(19) United States
(12) Patent Application Publication
(10) Pub. No.: US 2001/0048837 A1
(43) Pub. Date: Dec. 6, 2001

(54) Keyboard improvements that can be implemented

(76) Inventor: John Victor Parkinson, Santa Maria, CA (US)

Correspondence Address: John V. Parkinson, 708, East Cook St., Santa Maria, CA, 93454, US

(21) Appl. No.: 09/766,149

(22) Filed: Jan. 18, 2001

Related U.S. Application Data
(60) Provisional application No. 60/177,747, filed on Jan. 21, 2000.

(51) Int. Cl. B41J 5/26

(52) U.S. Cl. 400/489; 400/472

(57) ABSTRACT

Family or series of compatible keyboards for computers, etc., progressively modifies Standard, introducing new standard keyboard (191) with rationalized logic, everything integrated into alphanumeric section (FIG. 19). Existing skills are entrenched. Radical change is unworkable. Standardization prevents undirected piecemeal change. This invention ends deadlock, provides direction, enables change by: versatility, allowing partial change for any market niche; compatibility, allowing transfer of new skills to new standard; transitional models teaching such skills; multi-mode models for different operators; ultimate universal design optimized for adults, children, novices and experts. Keyboard (71) has reversible segment (73) selecting traditional or symmetrical columns (FIG. 7). Same feature on fixed keys (FIG. 14) integrates central cursor keys (144). Symmetrical keyboard conforms to existing Standard (FIG. 13). Top row eliminated by selecting numerals on home row (FIG. 17). Multiple shifts for index finger or thumb, allow one-handed or two-handed operation, and select natural character groupings (FIG. 18).

### CROSS REFERENCE TO RELATED APPLICATIONS

This application claims priority based on U.S. provisional application No. 60/177747, filed Jan. 21, 2000. Without further priority claim it uses letter allocations from related U.S. Pat. No. 6,053,647 entitled “User-Friendly and Efficient Keyboard”, which was filed Jul. 29, 1998 and issued Apr. 25, 2000.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

This invention relates to keyboards providing a manual interface between an operator and equipment such as typewriters, computers, communications systems, or other equipment using alpha-numeric data. More specifically, it relates to the standardization of keyboard design under ISO/IEC 9995, with particular regard to operating skill and other factors affecting the process of changing the standard.

For ease of understanding and economy of presentation, some reference to the prior art is made in the detailed description of the invention.

The present state of the art has three distinct components useful to understanding this invention. The first component includes the formally standardized features of International Standard ISO/IEC 9995, Information Technology—Keyboard layouts for text and office systems—Parts I and II. (Hereinafter, “the Standard”.)

The second component includes those other features, such as columns of keys all leaning to the left and the “QWERTY” letter arrangement, that are not required by the Standard, but are informally standardized in the real world by tradition or custom.

The third component includes proposed design improvements that have never been implemented or generally adopted, such as those illustrated in many published patents.

Interacting with these components and with each other, less clearly definable factors include the pool of existing typing skills, market forces, the historical difficulty of typing, and general perceptions and expectations.

Although discussion here is mostly limited to English-language word processing on typical U.S. computers, the Standard generally covers all keyboard applications in a multi-lingual world-wide market, and this invention is intended to do the same. Standardization, both formal and informal, has stifled progress, and is itself the major problem with the QWERTY or Standard keyboard. Prior artisans have failed to recognize this. They offer design solutions, but make no provision for implementing them in the real world. This invention addresses problems of implementation as well as those of design, and now, after a century of stalemate, provides a workable solution for progressing beyond the existing Standard to a proposed new and improved one (hereinafter, “the new standard”).

FIG. 1 (prior art) shows for discussion a typical Standard computer keyboard (11). It is well known that the design of the alphanumeric section (12) is firmly entrenched and has changed little in 130 years, even though it is grossly unsuited to its primary applications, which are now electronic, not mechanical. One problem is that the Standard uses some inappropriate technical requirements to define the keyboard, unnecessarily restricting design freedom and progress. For example, keyboard horizontal dimensions for the desired range of hand sizes could be regulated by the key spacing in the home row alone, but the Standard requires the spacing to be the same throughout the alphanumeric section. This restricts adjacent columns of keys to being parallel, which cannot adequately match the natural movements of adjacent fingers. The purpose of standardizing keyboards is to ensure compatibility between products and people, not between two products directly. Unlike a nut or bolt, the human half of the interface is highly adaptable, especially when a design variation makes the task easier. The critical relationship is between the mode of operation of the keyboard and the skill of the typist, and the measure of compatibility between keyboards lies not their identicalness, but in their shared operational compatibility with this external entity. Any future formal standard may benefit from such requirements being defined in terms of the elements of operator skill required, instead of in terms of specific technical features in the hardware.

However, the Standard itself is only one of several factors which together prevent any change. Another is the piecemeal approach in much of the prior art, which leads to incomplete solutions. The Standard requires that it be shown how a keyboard maps to the Standard's key position reference system, and requires that the alpha-numeric section has about a dozen features, most with inherent problems like poor shift positions and minimum counts of graphic keys in specific locations within that reference system. Other problems such as lack of symmetry are not formal requirements, but are equally entrenched informally. Any change must either conform to the existing standards, or solve all of these problems at once and create a new standard. However, both Herzog (U.S. Pat. No. 4,669,903) and Cleveland (U.S. Pat. No. 5,476,332) for instance, have arrangements with lateral symmetry but ignore long reaches and difficult, little-finger shift operations. They remain as hypothetical improvements that cannot be implemented because they are incomplete solutions that break the Standard without replacing it. The present situation is that Standard keyboards are supplied with computers largely because no-one can use any other, but no-one learns any other because none are readily available. It is a difficult loop to break, and doing so requires many conflicts and problems to be resolved simultaneously.

The physical layout makes it difficult to form a cognitive map, and the chaotic letters are hard to find, so hunt and peck typing is frustrating. There will always be occasional users; the keyboard should accommodate them. Despite the asymmetrical columns of keys, touch typing is a better method, and, recognizing today's dominant application, it should be refined and extended to include full computer control. It should be easy to master in elementary school, but is so difficult that 25 WPM can earn college credits. The need for the skill has spread from paid typists to the entire population, but the daunting prospect of learning to type discourages many people from trying to use a computer. The basic touch typing concept of not looking at the keyboard is ignored, e.g., this essential habit is undermined by providing lights as status indicators. Psychological factors are not recognized, e.g., the multiple choice (one row or two?) for upward movements slows the operation from simple to choice reaction time. It also adds complexity, reducing confidence and encouraging the typist to look at the keys for confirmation. Forcing the hands to move to peripheral subsets of keys undermines the technique of keeping the hands in home place, and it encourages looking at the keyboard. The keyboard is a unitary interface, not a collection of components; key locations should be based on use, not on arbitrary function classifications, e.g., editing keys should not be separated from typing keys since many people make corrections as they type.

Many poor design features are rooted in mechanical constraints. The large character groups dictated by a single shift need too many keys to reach easily. The logic suffers too because letters and numerals are mixed, and symbols are “upper case numerals”. For limited capacity segments, more was better, and the Standard calls for minimum numbers of character keys appropriate to those, instead of maximum numbers good for human hands. Binary codes now set the limit, but some are wasted on obsolete characters. On equipment not limited by the fixed mechanical spacing of a typewriter, two apostrophes work just as well as the double quote symbol; and on a computer the underscore character cannot even be used for its original purpose, and is not as good as other methods for drawing lines.

Conversely, other characters that should be provided are missing. In some countries the traditional decimal point is a middle-height dot, but it is not available on the international standard keyboard. There is a strong case for adopting it internationally. Whatever foreign conventions use for the decimal point, and no matter how bad the print quality may be, by virtue of its height above the line, the middle dot can never be confused with a comma, full stop (period), or apostrophe. So units cannot be misread as thousands, or vice versa, and decimal points cannot be confused with dimensions such as feet and inches. This dot also distinguishes conceptually between the mathematical decimal point and grammatical punctuation marks, helping children understand basic arithmetic. Providing characters on the keyboard is necessary to allow corresponding change in the binary codes.

Rapid change and haphazard growth have created anomalies, and the underlying organization of the keyboard defies all attempts to teach it logically; e.g., the unrelated Enter and Return functions are on the same key, and commands are confusing because they can be issued in several different ways.

Despite the large number of keys available, in order to assign a personal routine, a user may have to search for some unused, meaningless combination of keys intended for other purposes. Such non-standard requirements can only come from application software on one side of the keyboard interface, or the keyboard user on the other side of the interface; both sources should be recognized.

Although mouse and keyboard are standard with most desktop computers, they do not fit well when typing. The numeric keypad is exactly where the mouse pad should be, and with repetitive use, shoulder problems are increased by the excessive distance between home keys and mouse. A separate problem is the desktop required even when a task only rarely needs a mouse. Even a moderately efficient mouse alternative would allow occasional use of a keyboard on the knee.

Computer requirements now seem stable, and the whole keyboard should be rationalized. Although it alone cannot provide software dependent features, it must provide the capability so that software can be developed.

The prior art shows many failed attempts at improvement. Good design is the optimum compromise between all requirements, and this balance has generally been lacking. Dvorak (U.S. Pat. No. 2,040,248) focused exclusively on robot-like efficiency, and his scattering of letters looks random and no better than qwerty. He should have balanced efficiency against user-friendliness. At the opposite extreme, Stonier (UK patent 2,110,163) aims exclusively at user-friendliness and completely ignores the physical efficiency of finger movements.

In prior-art “ergonomic” over-reaction, much effort has been misdirected, e.g., elaborate designs raise the center of the keyboard when the need can be eliminated by simple work-station adjustment: setting the keyboard lower turns the hands flatter. Other designs fail to balance the abilities of the hand against its limitations, fail to recognize that individual differences and other priorities render anatomical perfection impossible and irrelevant, and rely on inaccurate analysis. For example, Lichtenberg (U.S. Pat. No. 5,336,001) wrongly assumes that rows of keys should be “perpendicular to the forearms” in a deep vee formation. Clearly, with the relaxed hands over the keyboard, the home row should align with the fingertips, but this indictates an angle of less than seventy degrees to the forearm, not perpendicular. This angle almost filly compensates for the inward angle of the forearms, resulting in an “ideal” home row with each half at an angle of no more than four or five degrees in a very shallow vee. However, the angle of the rows (and curvature, if any) is easily accommodated by finger curl or extension, so the exact layout is not very critical, and traditional simple straight rows across the board are a good compromise in a standard design for broad application. What's more, for keys within easy reach, little is gained by fine-tuning their locations, but if a row is beyond easy reach, fine tuning its shape or angle will never make the key locations acceptable. The real problem is too many rows. Solving that eliminates many others.

The column angles are more critical because the fingers do not adjust so readily sideways, but once again the typical prior-art analysis comes up lacking. The natural movements of the finger-tips indicate proper column alignment, but this is not the direction pointed by the forearms, shown in UK patent 1,016,993 in IBM's figure six at 30°, nor is it directly away from the typist as seen in Harbaugh (U.S. Pat. No. 5,584,588), Malt (U.S. Pat. No. 4,244,659) and Crews (U.S. Pat. Nos. 5,017,030 and D 287,854). Normally the palms are not parallel to the desk top, so curves traced by the finger-tips are not in vertical planes and do not project straight lines onto the desk. Straight lines substituted for the curves projected onto a keyboard show that the little finger tips move almost vertically up the keyboard, the lines leaning inwards slightly. Working towards the center of the keyboard, the line of movement for each successive fingertip leans in about an additional four degrees. An average for parallel columns for one hand is less than twenty degrees, roughly half the angle favored by workers who simply follow the angle of the forearms.

Some proposals abandon qwerty but introduce a new set of problems. IBM, Malt and Crews show variations of hand-print designs, but the better they fit one hand, the more problems they create for hands of a different shape or size. Crews also has a chording system using either one key, or two keys simultaneously, but the skill required to strike two at once without first getting an unwanted single-key character prohibits this system for people of ordinary ability. Also, chords are counter-intuitive, difficult to label, and unsuitable for occasional or new users. Further, using at least two key-strokes per character can, by that measure, be no more than half as efficient as traditional keyboards. Hand-prints and chords are not suitable for a general-purpose standard for use by adults and children of all races, and all skill levels.

The concave IBM shape and radical formats such as pyramids and balls are also unsuitable. A standard must lend itself to economical production, and suit portable as well as desk-top computers. This prohibits compound curves or significant third dimensions as essential design features. The new standard must first work well as a basically flat keyboard, which can then be adapted as desired.

Even if it is suitable as a new standard, a well-designed, purpose-built computer keyboard is not a complete solution; public demand will not take care of the rest. If competing old and new standards were in the market together, no-one would know which one to support. Any transition would be slow, confused and uncertain. Disruption would be maximized. Personal lives, job skills, and business are all affected, and a slow and uncertain transition is not an acceptable or workable solution.

The only workable solution is if the old and new standards co-operate to implement a rapid transition with minimum disruption. Allowance must be made for typists to retain their old skills, or learn new ones compatible with the new standard, according to individual needs. Equipment shared by different users raises uniquely difficult problems. Switching letter arrangements electronically is easy, but re-aligning the keys is impracticable. A unified design concept is needed, versatile enough to meet all market demands within the spirit, and skill transfer requirements, of the new standard. Understanding of skill transfer, lacking in the prior art, is needed before this can be contemplated.

The mental and physical components of touch-typing skill have different learning and modification characteristics. Mental information about which finger goes to which row for a given character is either right or wrong. If a change makes it wrong, errors provide no self-correcting feedback. The old knowledge must be “buried” by learning and strongly reinforcing new information. Minor changes with few cues from associated major changes are more likely to allow old information to surface. Moving the shift key up just one row (Cleveland) or sliding all the numerals just one place to the left (Lichtenberg, also Zilberman in U.S. Pat. No. 5,156,475) is confusing, difficult to assimilate, and may cause more long-term problems than a dramatic change, such as moving the shift to a completely different finger or reversing the entire sequence of the numerals.

In contrast, physical motor skills are very much subject to partial errors, and inaccuracy gives instant biofeedback for error correction. In his split-qwerty design, Louis (U.S. Pat. No. 5,503,484) teaches exact physical replication of the qwerty key layout for the left hand, but three factors combine to render this unnecessary. First, motor skills are learned using repeated bio-feedback to correct inaccuracy, and are perpetually monitored and corrected the same way. Tactile feedback from features like concave keytops enhances the process. Minor changes in key locations can be assimilated without conscious effort, and even major physical changes are easier than letter assignment changes. Like driving an unfamiliar vehicle, the pedal height, angle, and operating pressure may be different, but the driving skill tranfers so long as the brake is not on the right. Second, the body is naturally “lazy” (or efficient), so repetitive movements reduce to the easiest possible. This is part of the higher error rate for the left hand as it makes easier movements than needed by qwerty. Adaptation is natural if the new movements are easier than the old ones. Third, symmetrical operations are natural to our symmetrical bodies, and there is transfer of learning by symmetry between opposing limbs. Right-hand experience will aid the left hand if the left keys are made symmetrical to the right. Thus, key layouts can be substantially changed (in the right direction!) without unduly compromising skill transfer. Exact replication is only necessary for arbitrary conformance to the traditional layout.

To construct a new standard, all this must be weighed and balanced in combination. The problem is complex and its solution challenging, but the right new standard should be known by its elegant simplicity. The computer is not only a business machine for trained professionals, it is a toy and a tool for everyone from astronauts to children. Making notes on Martian topography affects few, but for children learning the alphabet and more, the keyboard can affect entire populations.

### BRIEF SUMMARY OF THE INVENTION

In accordance with the above, the main object of this invention is to balance all conflicting requirements and solve all identifiable problems, in a simple and complete keyboard design suitable for adoption as a new standard and supported by dual-standard and transitional models to facilitate the implementation of that standard. Many subsidiary objects are necessary to meet the primary goal. For example, having recognized the diversity of individual needs, a further object is to provide adaptable design concepts enabling selection of innovative features, singly or in combination. Another object is to maintain compatibility for skill transfer. Yet another is to provide a new standard so easy to learn and use that people can abandon their skills and start again. Further objects will become obvious later. To this end I have invented a series or family of compatible keyboards.

The series starts with the prior-art Standard (FIG. 1) and ends with a new design (FIG. 19) optimized for adoption as a new standard. The series allows existing typists to adjust their skills towards the new standard, partially, completely, or incrementally according to individual needs, and also provides dual-standard and multi-mode keyboards that can be shared by users with different skills. The primary benefit of the series is that it enables and facilitates the implementation and adoption of an improved new standard keyboard with a minimum of disruption, whereas all previous attempts to progress beyond the existing Standard have failed. Families or series of related keyboards are unknown in the prior art.

In changing between standards, existing technology allows easy switching of letter allocations as desired; what is needed is a corresponding easy way to physically re-arrange the key layout. This is in effect made possible in this invention by a basic key arrangement that is very versatile. The keys in successive rows are offset horizontally from keys in adjacent rows by half the horizontal center spacing of the keys, in a pattern having internal symmetry (FIG. 4). Prior art has symmetrical columns of keys, but only about a vertical centerline; this pattern allows the selection of symmetrical pairs of columns anywhere in the array, including having the same symmetry when inverted. Using this pattern of keys, parallel sets of columns compatible with traditional keyboards can be provided (FIG. 5), and conform to the Standard. Symmetrical sets of columns can also be provided (FIG. 6) compatible with the new standard, as if with a different physical layout of the keys. Since the basic key pattern is identical for either set of columns, dual-standard keyboards can also be provided on which the user may select either kind of sets of columns. One way to do so is by reversing a segment of the keyboard (FIG. 7), in which case permanent dual labeling on the key-tops allows the appropriate character to be automatically selected for easy reading, eliminating the need for make-shift temporary labels. Another method uses a fixed array of keys (FIG. 14); the effect is still as if the keys were physically re-arranged, but the keyboard is simple and cheap.

The same key pattern is a common feature of all the family members for at least a group of four keys in a symmetrical cross on three rows in the central zone of the alphanumeric section (FIG. 14). In some models the cursor arrows are assigned to these keys. Whatever their assignment, they control the angle of the adjacent columns of keys assigned to the index fingers, and thereby establish an appropriate orientation of the hands. Since this is a fundamental factor when using a keyboard, it establishes a basic level of operational compatibility for skill transfer between models, while allowing some design freedom outside the central zone of the keyboard.

Although symmetry is a common goal in the prior art, no symmetrical keyboard has yet been provided that can be used where conformance to the existing Standard is mandatory. This series provides a symmetrical keyboard that does conform to the Standard (FIG. 13), and can therefore be implemented anywhere immediately. With known means to switch the letter allocations, this provides under the old Standard a keyboard with the two most fundamental elements of typing skill for the new standard, i.e., hand orientation and letter arrrangement.

A further transitional feature within the series is the capability for redundancy at many levels. This can be physical or operational, for multi-mode keyboards or for mere user preference. Examples are: retaining a redundant row of numerals keys while also providing a new thumb shift to select numerals on the home row; and arranging shift keys for a choice of operation by index finger or thumb, and choice of one hand or two for shift operations.

While the majority of the market may be served by the proposed new standard and one dual-mode model offering both symmetrical and asymmetrical columns, the inherent versatility allows other embodiments to cater to every significant group of existing users, whatever their preferences. For example, one embodiment of FIG. 6 provides for qwerty typists who want to relieve their aching wrists with improved bio-mechanical alignment, but who do not want to learn a different letter arrangement or new shift operations. However, the compatibility between the keyboards ensures that any new skills taught by such transitional models will transfer to the new standard should an individual subsequently choose to make the complete change. This approach is important to ensure that objections from various groups do not altogether prevent any change from the present Standard; implementation depends on popular perceptions, confidence and consensus, as well as on technical superiority.

The design of the efficient new standard enormously simplifies learning and use of the keyboard, and encourages the spontaneous development of touch-typing skill. The same easy skill is then applied to editing and full computer control, with a total of only fifty keys. Other advantages over the existing Standard include: increased speed; reduced fatigue and industrial injury; logical organization; suitability for all, including adults or children and occasional or full-time users; and savings in size, weight and cost.

Other individual keyboard designs may have some of the same benefits, but in the broader context the prior-art alternative is still “no change”. The thoroughness and completeness of this total solution brings about a synergy where the whole is greater than the sum of the parts. The historical stalemate, the great benefits of the new standard, its ease of implementation through transitional models, and the extreme unlikelihood of any possible alternative, are all readily apparent. Adoption of this new standard to meet the great existing need will therefore be perceived as secure, and this in its turn will help to generate the confidence and support required to ensure the smooth and rapid transition for which the series was created. The self-sustaining loop of stagnation will be replaced by self-propelled progression to a new and better standard.

### BRIEF DESCRIPTION OF THE SEVERAL VIEWS OF THE DRAWING

FIG. 1 (Prior art) shows a computer keyboard typical of the existing Standard.

FIGS. 2 and 3 (Prior art) show column structures with lateral symmetry about a centerline.

FIG. 4 shows a new column structure with vertical and lateral symmetry anywhere in the array.

FIG. 5 shows a modified parallel column structure in a portion of the FIG. 1 Standard keyboard.

FIG. 6 shows symmetrical columns on the key configuration of FIG. 5 rotated 180°.

FIG. 7 shows a multi-mode keyboard having a removable, reversible segment.

FIG. 8 is a detail of dual labeling for keytops in the reversible segment of FIG. 7.

FIGS. 9A and B are end elevations of a keyboard with a non-reversible profile.

FIGS. 10 and 11 are end elevations of keyboards with reversible profiles.

FIG. 12 shows the symmetrical columns of FIG. 6 in an array with all keys the same size.

FIG. 13 shows how FIG. 6 or 12 configurations map to the key numbering system of the Standard.

FIG. 14 shows alternate column selections on a fixed array of keys for a multi-mode keyboard.

FIG. 15 shows an array of keys with the maximum column spread attainable under the Standard.

FIG. 16 shows full column spread in a rectangular array of keys.

FIG. 17 shows an arrangement with an additional shift function and fewer rows.

FIG. 18 shows a fully rationalized arrangement optimized for easy touch-typing.

FIG. 19 is the complete proposed new standard keyboard with all subsets of keys integrated.

### DETAILED DESCRIPTION OF THE INVENTION

While the best mode of the series contemplated by the Applicant is illustrated in FIG. 4 through FIG. 19, the examples presented do not exhaust the series. As will be obvious to a person skilled in the art, features may be used alone or in other combinations to suit applications in any particular market niche. Also, many of the features are tailored to the requirement of being adaptable, and although primarily intended for conventional two-handed and able-bodied operation, this should not be regarded as a limitation. The order of presention was not arranged to reflect importance, but to introduce inventive features by comparison with familiar concepts, starting with a Standard keyboard. While one or two models or features may be considered the most important or popular, they alone do not constitute a “preferred embodiment”, since the completeness of the solution, and of the series, is fundamental to the success of the invention.

The Standard keyboard (11) in FIG. 1 (prior art) has an alpha-numeric section (12) with rows identified here as A through E following the Standard convention. In ten columns headed by ten numeral keys in row E, twenty-six letters and four punctuation marks make up the recognized basic alpha-numeric set on forty keys. Six letters in row D identify this as a “qwerty” keyboard. The Standard accepts other letter arrangements, including Dvorak.

In touch-typing each hand is assigned five columns of keys, the two inner ones near the keyboard center being assigned to the index finger, and one each to the other three fingers. The home keys are in row C.

The columns are not vertical because the keys are offset horizontally from the keys in adjacent rows. They are not straight because the offset varies for different pairs of rows. For rows B and C the offset is one half of the key center-spacing (½-key). For rows C and D it is only ¼-key. Lines (13) up the keys of any column therefore zigzag. With the same offset between all rows, say, ⅜-key, the columns would be straight.

For row D relative to row C, the ¼-key offset is always to the left. The overall angle of slope of lines (13) therefore depends on column selection, leaning either to the left about 23° away from vertical, or to the right about 30° from vertical. No symmetrical columns exist. Herzog (Col 4, lines 26-47) achieved lateral symmetry by using a symmetrical offset in left and right halves of the keyboard, instead of always to the left.

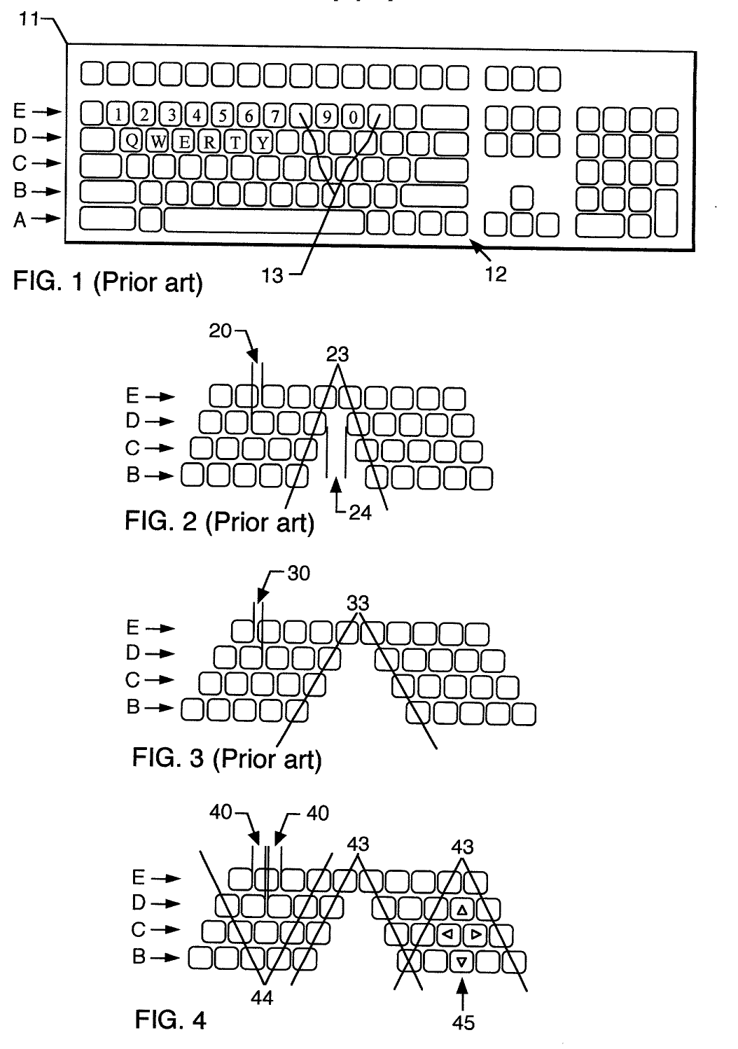

A symmetrical constant offset of ⅜-key can create two different arrays. FIGS. 2 and 3 (prior art) show part of FIG. 1, with possible re-arrangements of the basic set of forty keys according to prior art. FIG. 2 is an array with a ⅜-key offset (20) measured outwards going down the rows. FIG. 3 is an array with a ⅜-key offset (30) measured outwards going up, which is the same as a ⅝-key offset measured outwards going down. Lines (23) in FIG. 2 and (33) in FIG. 3 differ only in their angles of slope. Other values of offset can create any desired angle.

Herzog shows a keyboard similar to FIG. 2. Columns leaning 10° away from vertical leave no room for a key in space (24) in row D, i.e., it has less than ½-key offset measured outwards going down.

Cleveland (col. 1, line 23) says Herzog makes inefficient use of the triangular space located in the center of the keyboard, and he modifies a conventional, Standard keyboard to create the type of array shown here in FIG. 3. Specifying (col. 4, line 8-9) “a new alignment of . . . fourth row 40 in relation to third row 30,” (corresponding to rows B and C here) Cleveland rejects the standard ½-key offset between these rows in favor of any other symmetrical offset sufficient to make room for more keys in the middle, i.e., any offset greater than ½-key measured outwards going down.

Herzog and Cleveland each show prior-art keyboards having a symmetrical, constant, horizontal offset between the keys in adjacent rows. Each has lateral symmetry about a common centerline for several pairs of columns of keys.

In FIG. 4, this invention shows an improvement wherein said offset (40) is ½-key. Pairs of lines (43) can be anywhere and be symmetrical. Two positions are shown by way of example. Inverted columns such as lines (44) are equally symmetrical. FIG. 4 has a higher level of symmetry than FIG. 2 or FIG. 3, an internal symmetry in the key pattern. Different column configurations can be selected without physically changing the key layout. The ½-key offset (40) also permits the selection within the array of a group of four adjacent keys in a symmetrical cross, for example, group (45) identified by triangles.

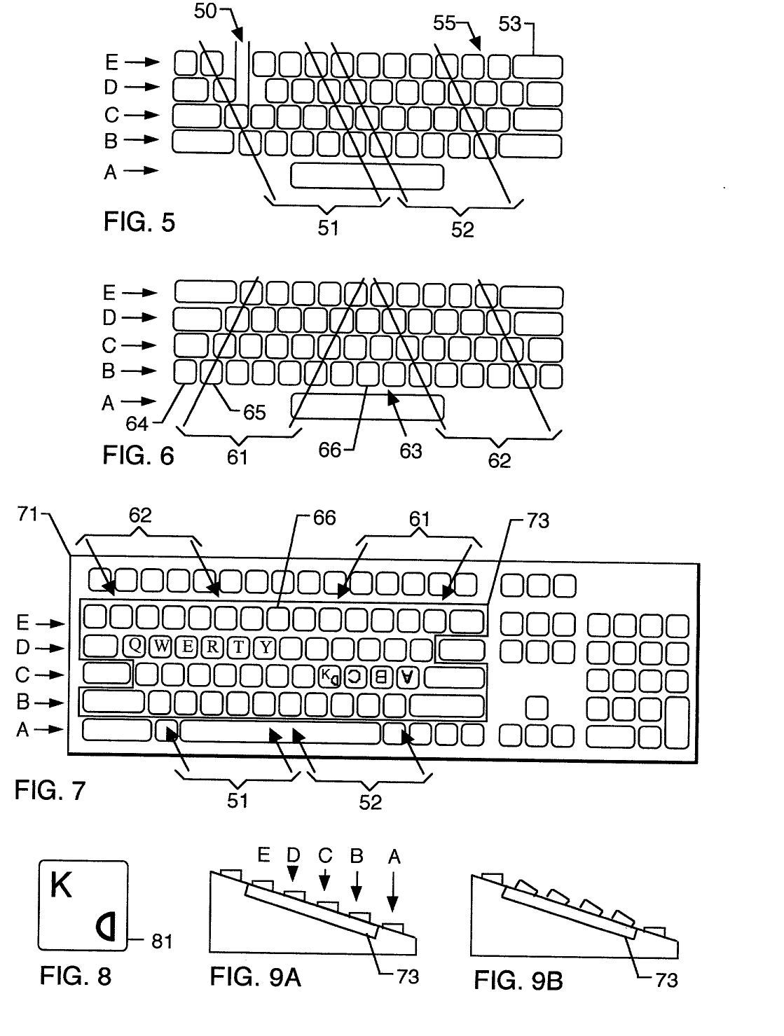

FIG. 5 shows internal symmetry applied to part of FIG. 1 in an otherwise traditional keyboard made physically compatible with others in the family, while being operationally compatible with traditional models. In row A, only a spacebar is shown. In rows D and E, a key is omitted for clarity. The key count is 12, 13, 14, 14 in rows B, C, D, E respectively. In FIG. 5 compared to FIG. 1, one change is made: the horizontal offset (50) from row C to D is changed from ¼-key to ½-key. Other offsets remain unchanged at ½-key. This conforms to the Standard, and does not much affect existing skills. Traditional touch-typing uses the straightened columns of groups (51) and (52) for the left and right hands respectively. For neat appearance at the ends of the rows, keytops such as key (53) may be adjusted in size in the usual way.

Rotating 180° about an axis perpendicular to the strike surface of the keys, both lateral and inverted symmetry are applied to FIG. 5. Key (53) moves from the top right corner to the bottom left corner. The key count per row is reversed. In this reversed orientation in FIG. 6, two standard-sized keys (64), (65) replace the oversized key (53) of FIG. 5, making the E to B key count 12, 13, 14, 15. Symmetrical groups of five columns (61), (62) can now be selected for the left and right hands. Key (64) becomes the shift key, and key (65) is included as a character key in the basic set.

The symmetrical columns of FIG. 6 can be used in a single mode keyboard for qwerty typists wishing to relieve their aching wrists with a minimum of retraining if columns (61), (62) have characters that maintain the qwerty relationship with each finger. Characters from a group (55) of five keys in FIG. 5 are re-assigned in FIG. 6 to five of the six central keys (63). The sixth key (66) can be eliminated so all the finger keys are in or next to the ten primary touch-typing columns, thus eliminating all the long sideways reaches. Skilled Dvorak typists can receive the same benefits.

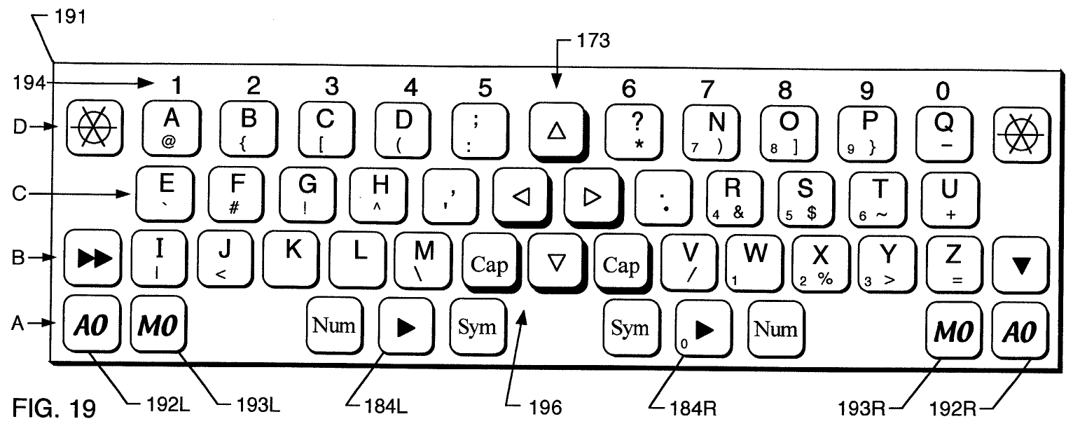

Another embodiment has the alphabetical letter allocations seen in FIG. 19, as original allocations or by switching software. This embodiment is then compatible with two major features of the new standard, i.e., ergonomically sound symmetrical columns, and user-friendly and efficient letter allocations.

Another application combines FIGS. 5 and 6 in the multi-mode reversible keyboard (71) shown in FIG. 7. This is a luxury model with automatic self-selecting permanent dual labeling. A portion or segment (73) of the alpha-numeric section is easily removed. The segment can be turned 180° and replaced in the reverse orientation, offering a choice of symmetrical or traditional columns. As shown in FIG. 7, traditional columns (51), (52) from FIG. 5 are available for use, and the qwerty letters appear in row D. When the segment (73) is reversed, symmetrical sets of columns (62), (61) from FIG. 6 are ready to use, and letters ABC replace QWE in row D.

In the traditional mode, key (66) is used for the numeral seven in the middle of row E, so it cannot be eliminated in this embodiment and may be left unused in symmetrical mode. Similarly, one of the keys (64), (65) may be left unused in traditional mode, or both can have the same function as key (53).

If all the keys are similar, the removable segment is a simple rectangle that includes them all. Any special key, say, a locking shift, would be wrongly placed when the segment was reversed. In this case, the segment (73) has a gap at each end as shown. The removable segment has all of rows B, C, D and E, except for the left-hand key of row C and the right-hand key of row D. These keys are permanently mounted in the fixed portion of the keyboard. Each gap must fit round each fixed key according to the orientation in use, so the sizes must be matched. In FIG. 7 the right-hand key of row D has been increased in size to make both keys the same. End keys in the other rows are also extended to maintain the overall rectangular shape of the array.

FIG. 8 shows self-selecting dual labeling on a single keytop (81), with the letter K in the top left-hand corner, and an inverted D in the bottom right-hand corner. Other positions are possible. On reversal of the segment containing the key (81), D is the right way up at the top left, and K is inverted at the bottom right and easy to ignore. Makeshift temporary labels are eliminated.

FIG. 9A is an end view showing rows A, B, C, D and E with horizontal strike surfaces at different levels. When the segment (73) is reversed as shown in FIG. 9B, the strike surfaces of the keys are no longer horizontal, so such a profile is not suitable for reversing.

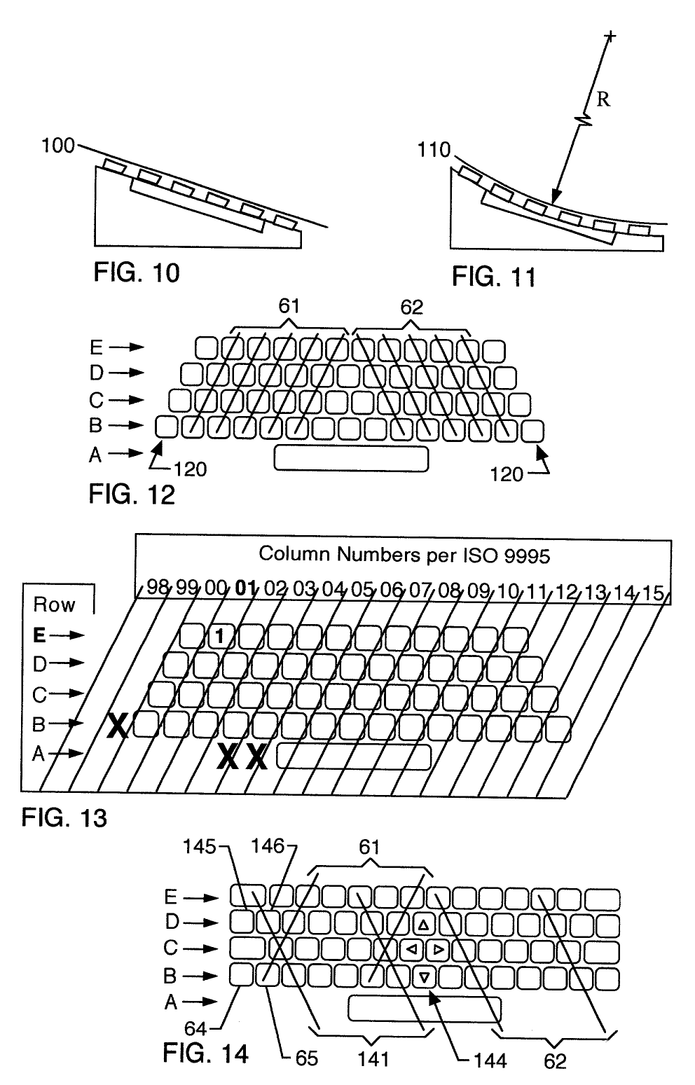

FIGS. 10 and 11 show end profiles with straight or constantly curved lines (100), (110) along the key strike surfaces. These lines could be symmetrical about an axis of reversal, so the profiles are suitable for reversing.

Reversibility can be applied at any level from factory to end user. Common stocks of parts for different models of fixed keyboard may save cost. Big companies may program one-time reversal of many keyboards. Individual pieces of equipment may undergo regular reversal by different users. Whether tools are required, or whether thumbscrews or spring latches are used to retain a segment in a keyboard, depends on the needs of the specific application.

On existing keyboards, irregular oversized keys are used to present a neat appearance. With a constant offset between rows, this is not necessary. FIG. 12 shows the same columns (61), (62) as FIG. 6, but the oversized keys in the end columns (120) have been replaced by normal keys. This allows cost savings, and the trapezoidal style may be preferred, or fit better into portable equipment.

FIG. 6 or 12 can conform to the Standard. FIG. 13 maps FIG. 12 to the Standard row-and-column key position reference system, which allows columns at any angle. These are not the numbered columns of FIG. 19, or the touch-typing columns in any figure. Examining FIG. 12 for meeting the Standard, one skilled in the art will find that it conforms in all respects except at locations marked with a large X. The spacebar must be extended leftward about two columns to at least partially occupy position A03. For symmetry, it can be extended equally to the right. The Standard also requires that a left-hand shift key at least partially occupies position B99. The shift key shown must be extended to the left into the adjacent column. For neat appearance and symmetry, other end keys may also be extended. In other respects the layout meets the requirements for the minimum number of keys per row, the columns they must occupy, etc. With no more than normal attention to detail, for example, extending keys as necessary and locating unrestricted functions where keys are available, the configuration provides a symmetrical keyboard conforming to the existing Standard.

FIG. 14 shows a simple, fixed, low-cost multi-mode configuration without the benefit of self-selecting, dual labeling. Typed characters can easily be checked on the screen and then erased, and if one mode has maximum resemblance to qwerty for typists with long experience, labels for that mode are superfluous anyway; single labeling is then all that is required. Other versions that need dual labeling can still use existing methods such as plastic overlays or color-coded labels.

In FIG. 6 oversized keys at each end of rows D and E waste space. In FIG. 14 each of those four keys has been replaced by two keys, thus providing four additional keys within an array of the same size. The key count per row is now 14, 15, 14, 15 going from row E to row B.

Symmetrical groups of columns (61), (62) can be selected. If the array was inverted (or if we started with FIG. 5 instead of FIG. 6) so the top to bottom key count was 15, 14, 15, 14 it would not be possible to select symmetrical columns and still have room for two shifts in row B.

To select parallel or asymmetrical groups of columns similar to groups (51), (52) in FIG. 5, there are several possible choices. Adjacent groups can be selected identical to FIG. 5, or moved in unison one key position either way; or the groups can be separated by one key or by two keys. The choice depends on the primary use. FIG. 14 provides maximum separation between the group (141) for the left hand and the group (62) for the right hand, while leaving the right-hand end key of row B available for the shift function. No similar extra key is needed in row E, so the group (141) can include the left-hand end key of the array in row E.

With suitable electronic switching of key functions, the keyboard user can select the preferred column arrangement, thus providing a very simple multi-mode keyboard on a fixed array of keys.

Adjacent groups of left and right-hand columns maximize qwerty compatibility. For typists with existing skill, separating groups (141) and (62) as shown in FIG. 14 has the disadvantage of displacing a character key from the left end of row E, and three more from beyond the right side of group (62). These keys are relocated between groups (141), (62). Since they were in poor locations to begin with, relocating them more conveniently between the index fingers is not much of a disadvantage.

With this particular choice of asymmetrical columns, left and right groups are separated by two keys. This separates the hands and reduces wrist strain while retaining the angle between rows and columns. The identical home row including any tactile indicators, and the same right hand portion, is used for both modes. The home keys are symmetrically disposed within the home row C, and are adjacent to the Return/Enter key for a shorter sideways reach. Labeling is simplified, particularly for asymmetrical qwerty/symmetrical qwerty combinations.

The FIG. 6 arrangement had one more key than the usual qwerty keyboards, and in FIG. 14 this is used as follows. In the mode using the asymmetrical left-hand columns (141), the adjacent key (65) in row B becomes the left-hand shift. The end key (64) duplicates the shift function. In the symmetrical mode, the two keys (145), (146) at the left end of row D are similarly used for the tab function. Duplicating keys in this manner allows the typist to find the function either from the end of the row, or if preferred, as the key adjacent to the little-finger home column.

Since four more keys have been added, there are enough to incorporate four cursor control or arrow keys, which are usually in a separate editing subset in an inverted “T” on two rows. Schmidt (U.S. Pat. No. 4,522,518) shows a central matrix of keys including arrow keys in a single column across four rows, or split for left and right hands in three rows. A cross formation on three rows with “up for up” and “down for down” is better, especially when readily accessible to the index fingers of either hand. Harbaugh shows such a cross in a keyboard having cursor arrow keys arranged on three rows within an alphanumeric section. However, Harbaugh's cross formation has an undesirable fifth key at the center. FIG. 14 shows arrow keys identified by triangles, in a group (144) that eliminates the undesirable fifth key from the symmetrical cross. This illustrates an improvement having a left arrow key immediately adjacent laterally to a right arrow key.

This embodiment uses the same cursor group in both modes, so it can have permanent labels.

If this cross determines the pattern of keys at the center of a keyboard, it provides a simple way to ensure compatibility between different keyboards without unduly restricting design freedom. Any sensible configuration built around it will have adjacent columns assigned to the index fingers that establish a constant and reasonable orientation of the hands with respect to the keyboard. At the same time, significant opportunity remains for variations for design improvement or preference outside the central zone. Non-identical, compatible keyboards are unknown in the prior art.

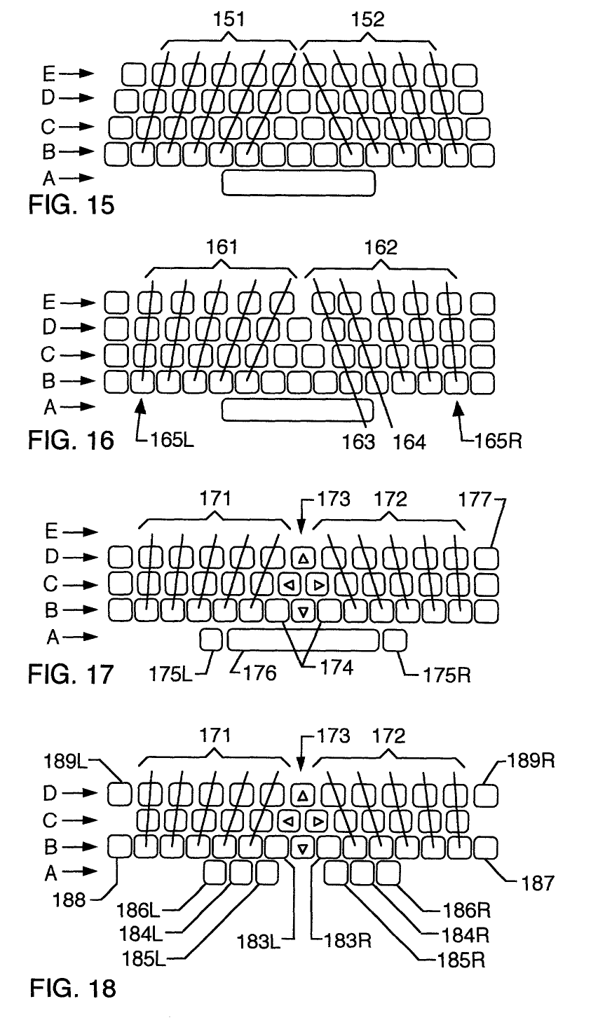

The column alignment can be fine tuned. FIG. 12 has all five columns parallel within each group (61), (62). It has gone almost as far as it can go under the Standard, but the bio-mechanical alignment is only a first approximation of what is wanted. FIG. 15 is similar, but takes advantage of permitted dimensional tolerances. The horizontal key spacing is increased to the maximum in row E, and reduced to the minimum in row B. Intermediate rows are adjusted to maintain straight columns. Going up the rows from B to E, this yields columns that spread out to the maximum extent allowed by the Standard.

In FIG. 16 key spacing is adjusted so rows B through E are the same length in a rectangular array. The spreading columns in each group (161), (162) closely match the natural movement of the respective fingertip. With respect to home row C, they all lean inwards towards the center of the array. Lichtenberg has spreading columns, but some lean outwards with respect to the home row, effectively sharing the qwerty left-hand misalignment between both hands instead of correcting it. This arrangement has about four degrees of inward lean for columns (165L), (165R) assigned to the little fingers. For the columns towards the center, the angle progressively increases. Variations are possible and a range of angles is acceptable.

Shown for the right hand only in group (162) is a possible variation for column (163). The two innermost columns (163), (164) are assigned to the index finger. The longest reach, from the home key to the upper key in column (163) row E, may be slightly reduced in a number of ways, and in FIG. 16 columns (163), (164) are shown parallel. They lean about 20° away from vertical. If this feature is used for the right hand, it would also be used for the left hand for symmetry.

Using home row C for comparing keyboard sizes, if the key spacing in row C is normal, then this array is fourteen key-spaces long. Since row B of the same length contains fifteen keys, the key size may be reduced to maintain clearances. Using the same size keytops throughout the keyboard and maintaining substantially even spacing within any one row, the clearances are greater in row C than in row B, and greater still in row D which has only thirteen keys spread out over fourteen key spaces, etc.

For a general application, the column alignment of FIG. 16 has reached the useful limit of development. It will work very well in any application if 12, 13, 14 and 15 keys per row are simply distributed across the length of the keyboard.

FIG. 17 has only three rows of character keys, with an additional shift function to select numerals on the home row. For upward movements with row E eliminated the decision tree is simplified. Long stretches are eliminated and finger movements reduced to “one up or one down”. This also effectively perfects the column alignment since it is less critical with the maximum movement halved from two spaces to one. The keyboard becomes far more tolerant of bad posture and variations in hand shape and size. For multi-mode models a redundant row E can be retained. Numerals and symbols may then be typed traditionally on row E, or by using the new shift. The embodiment shown is arranged to maximize similarity to traditional keyboards. The backspace displaced from row E moves to key (177) of row D, displacing the characters from that key, but other keys in the end columns keep the same functions. Groups of columns (171), (172) are shortened versions of groups (161), (162) in FIG. 16, and carry the same set of letters and punctuation marks. This basic set now contains thirty keys instead of forty.

Row A has a new symmetrical pair of thumb-operated shift keys (175L), (175R) either side of spacebar (176). This shift selects a new set of thirty characters. Numerals are selected in order from left to right on home row C. The traditional symbols are selected on row D above the associated numerals. Ten of the graphic characters displaced from positions outside the basic ten columns are selected on row B below the numerals. This includes all but four of the characters on present keyboards. The remaining four are assigned to a pair of keys (174) either side of center in row B; with the new second shift, these keys have spare capacity for two more characters.

The cursor control arrows are assigned to the remaining group of four central keys (173). They are mounted with their strike surfaces raised slightly above the level of the character keys to provide a tactile landmark that distinguishes them from the character keys and permits home row and home place to be found with the index fingers.

FIG. 18 optimizes keyboard operation for easy touch-typing, and establishes the basic layout of the proposed new standard keyboard. Columns (171), (172), and cursor keys (173), are the same as in FIG. 17, and already in an excellent touch-typing configuration. The traditional spacebar is replaced by two ordinary keys (184L), (184R), symmetrically disposed in convenient home positions for the respective thumbs. Other keys and the keyboard organization are also changed.

All graphic characters, and only graphic characters, are assigned to the thirty keys in groups (171), (172). The traditional two shift levels each containing sets of forty-plus mixed characters are replaced by four natural sets of thirty characters each, giving adequate capacity in each set and in the 120-character total. The sets provided relate clearly to these natural divisions: small letters; capital letters; numerals; and symbols. The default set is small letters, and in English language versions includes four punctuation marks with the twenty-six letters of the alphabet, as is customary. Three independent shift functions each select a different character set. A Capitals shift function (Cap) changes small letters to capitals, but does not change the punctuation marks. Increased capacity allows duplication of punctuation in both sets. This is easier to learn and use, and eliminates the need for differences between shifted and shift-locked character sets. As early as 1917, Banaji (UK patent 116,538) had patented two identical punctuation marks per key. A Numerals shift function (Num) selects ordinary numerals in place of the letters on the home row C. If superscript and subscript numerals are available, these are respectively assigned above and below the home row in rows D and B. Thus an entire column of three keys is associated with each numeral. A Symbols shift function (Sym) selects a fourth character set including all the symbols on many present keyboards except the four punctuation marks assigned to the alpha sets. These twenty-eight symbols leave room on the keys for two more. If sufficient character codes are available, additional symbols like a middle dot for the decimal point can be provided. Otherwise some keys are not used in Sym shift mode, and the middle dot may replace, say, the double quote character.

The shift and shift-lock functions have identical character sets and are combined on one key. Each shift function operates normally by holding down the key while typing a character. The lock is engaged electronically by double-clicking the same key, i.e., two operations of the key within a pre-determined time interval that is preferably user-adjustable. The lock is disengaged by a single touch. This combines knowledge of results with the physical simplicity of one plain keyswitch, all without having to look. If in doubt about the shift status, the typist simply touches the key once, which always leaves the lock disengaged.

To permit choice according to preference, especially for disabled users, alternative methods can be provided where the release uses a half measure of the locking method. If the lock is engaged by four shift key presses with no intervening operations and no time limit, it is released by pressing the key twice. If it is engaged by holding down the shift for two seconds without any other key operations, it is disengaged by holding down the key for one second.

Each shift function (Cap, Sym, Num) can be locked independently of the other two, and remains engaged until the lock is released. When more than one shift function is engaged, the one most recently engaged takes precedence as the active set. This permits the shift-selection of individual characters from other sets while a predominant set remains locked in. For example, the Cap or Sym shifts can select occasional punctuation or mathematical symbols between long numbers while the Num shift remains locked in.

Traditionally difficult, two-handed, little-finger shift operations are replaced by much easier index-finger or thumb shifts using central shift keys, which also provide the option of either two-handed or one-handed shift-character combinations. Variations in shift key locations are possible. Those shown reinforce understanding of the underlying classifications and permit choice of method of operation. For easy operation by the index fingers, the Cap shift keys are either side of center in row B, assigned to a pair of keys (183L), (183R). Their strike surfaces are raised above the level of the keys in row A to distinguish them from the character keys and to permit easy thumb operation without inadvertently operating the keys in row A. Sym and Num shifts are thumb shifts adjacent to the thumb home keys. The Sym shift function is assigned to keys (185L), (185R) inboard of the space keys, more or less below the Cap shifts. The Num shift is on keys (186L), (186R) outside the space keys, similar to the new shifts of FIG. 17. The thumb shift locations are also convenient for the index fingers, and readily identified by touch from the adjacent spaces. Thus, all the shifts can be operated by index finger or thumb with little movement from home place, and a typist may use whichever of these dominant digits is preferred for any shift in a two-handed operation. However, if a typist prefers to focus attention on only one hand, it is also easy to use the correct finger for a character key and the thumb of the same hand on any of the shifts in a simple one-hand chord, to avoid two-handed operations altogether.

The two unrelated functions of the Return/Enter key are separated. “Enter” is not a typing function and will be dealt with later. The term “space down” is more apt than “Carriage Return” for the remaining function. “Space down” is assigned to key (187) at the right end of row B. The “extended space” or invisible Tab character is symmetrically opposite, assigned to the key (188).

The Command function is assigned to keys (189L), (189R) at the top corners of the array. In an easy two-key combination for one hand or two, the dedicated Delete or Backward Erase key is replaced by “CommandSpace”, setting an appropriate Command-(character) precedent for a consistent method of issuing all keyboard commands. This completes all the basic typing functions.

FIG. 18 can be incorporated in a traditional style keyboard similar to FIG. 1, with additional subsets of keys dedicated to particular kinds of functions, Some benefits would be wasted.

FIG. 19 shows the physical layout of the complete proposed new standard keyboard (191), where subsets of keys are unnecessary. It can be used with any letter allocations, the exemplary set shown being an alphabetical “reads-like-a-book” arrangement that combines user-friendliness and efficiency in a way emminently suited to beginners and experts alike. The arrangement is fully disclosed in U.S. Pat. No. 6,053,647 to the present Applicant, of which the description is hereby incorporated by reference. The particular punctuation marks suggested in FIG. 19 for the default small-letter mode are the period, comma, semi-colon and question mark. Other selections are possible but these and the locations shown are preferred for their frequent usage, and their compatibility with other modes of operation. In this array and others with only three rows of character keys, numerals are selected as alternative characters on the home row C. When used with an array having four rows of character keys, such as FIG. 6, numerals are on row E as with present keyboards.

The new standard has only fifty keys to remember and reach. They are symmetrically arranged and can be all the same size. It incorporates the physical configuration of FIG. 18, and extends easy touch-typing to full computer control, integrating everything into the alphanumeric section. This is achieved by rationalizing the logic and providing only two more functions, AO and MO, on keys duplicated for left and right hands in symmetrical pairs (192L&R), (193L&R) at either end of row A. They are separated from the groups of typing keys near the center of the row by spaces that provide additional tactile landmarks.

AO is an Application Override that allows standard key functions to be overridden in ways defined by the Application, similar to the Alternate or Option function on existing keyboards. Manual Override MO has no direct equivalent on existing keyboards, and, in conjunction with the application, serves two purposes. It provides a full set of “Manual Override-(graphic character)” key combinations that can be assigned functions defined by the user; and it provides MOuse emulation on the arrow keys.

Ten columns of graphic keys are numbered 1 through 0 with labels (194) above the columns. For touch-typing, columns 1 to 5 are assigned to the left hand and columns 6 to 0 to the right. The gap in the column of keys at each end of the keyboard readily identifies the shorter home row C visually or by touch. Home keys EFGH and RSTU are the outer four keys immediately adjacent to these gaps, so the home positions can be found easily without looking.

The central key in row B, and in row D, and the central pair of keys in row C, together form a group of four keys (173) in a cross formation. Those in row C are offset horizontally by one half of their center spacing from those in rows B and D. This determines the approximate angle of slope of the nearby columns 5 and 6 that are assigned to the index fingers, which in turn determines the orientation of the typist's hands with respect to the keyboard, which in turn ensures a certain degree of operational compatibility between this keyboard and others with the same or a similar feature. In this case, the cursor control functions are assigned to these four keys, and they are marked with triangular arrow heads showing the direction of movement. Together with the Cap shifts, the arrow keys form a triangular group (196) of six keys with higher strike surfaces than the other keys.

For consistency of operation and to avoid unnecessary keys, dedicated command keys, including separate subsets of F-keys, are eliminated and the Command-(Character) format is used for all keyboard commands. Although letters and symbols are generally more meaningful than numeric commands, if numeric commands are preferred up to thirty are now available within the character sets. However designated, all commands are on familiar typing keys and within easy reach of the home row. “Delete” becomes “Command-Space”. The “Escape” key is replaced by “Command-Period”. With the period character now assigned to the right index finger in the home row, it will be found easily even by a beginner. Another command worthy of standardization is “Command-?” for accessing “Help”. Unlike Standard keyboards, in FIG. 19 this is correctly designated in both upper and lower case, and like the period, the question mark is easy to find with the right index finger.

So that all commands activated from the keyboard use the same key, the Enter and Command functions are combined. Unless the application detects Command key activity, at least when a command is pre-selected on the screen, a separate Enter signal is needed. One way to combine these functions is by taking advantage of their naturally compatible timings, one key sending first an Enter signal, then switching electronically to Command mode. If no command is pre-selected on the screen, etc., the Enter signal is ignored. On a human time scale, Command mode is instantly available for a Command-(Character) combination, much faster than the operator can ensure that the keys are pressed in the right order. To avoid “Carriage Returns” when the Command key alone is pressed, the Enter function must have its own code. One could be re-assigned from a non-essential character; however, since the Enter signal need only go as far as the computer, it need not be limited to seven-bit codes. With Enter and Command combined on one key by any method, Command selection can still be made beforehand on the screen, or concurrently on the keyboard, but the same key is always used to activate the command.

The preferred functional hierarchy of the keyboard has four levels. In general, Level 1 (the lowest) performs basic functions. Level 2 changes the way the same function is performed. Level 3 changes to a different function. Level 4 allows functions to be redefined by an outside source. All functions above Level 1 are provided for both hands on symmetrical pairs of keys.

Only one function per level can be active at any one time. Higher levels can modify lower levels, but not the same level or higher. Level 1 keys cannot affect other keys (except to inhibit them to avoid mixed signals). Level 1 has an inactive resting state and 37 active states comprising thirty graphic characters, three invisible characters, and four cursor control arrows. Level 2 has four states: the default state plus three shift functions. Level 3 has two states: the default typing mode and a Command mode. Level 4 has three states: the default state with functions as defined above; and AO and MO states with unknown functions dependent on an outside source.

In accordance with this hierarchy, shift keys can increase cursor movements and the Command key can change the function. Movement through the document to read it, and mouse emulation, conveniently done with the same arrow keys, are higher level changes that may not involve the cursor at all.

Default cursor movements of one character and one line are primarily text-related, so shift changes are consistently text-related as follows. For horizontal arrows, cursor movements are respectively increased by the Cap, Sym, and Num shifts to: either end of a word; either end of a phrase; and either end of a sentence. For vertical arrows, movements are respectively increased to either end of a paragraph, section, or document. In conjunction with the Command key, the text through which the cursor passes is selected in readiness for a command to be applied to it.

Document format and window size is linked to the application rather than the text, and is appropriate to AO mode, which may be locked for continued use. Within the hierarchy, there is plenty of scope to page, scroll or move to any part of a document, with or without inserting “bookmarks”, etc. For example, if AO-Command-B inserts a “Bookmark” at, say, the top of an open page or window, then in the same AO mode the following is possible: the Up arrow pages up one window; Cap-Up by one document page; Sym-Up to the first bookmark encountered; and Num-Up pages up to the beginning of the document. Command-Space deletes any bookmark at the present position, and Command-Cap-Space deletes all bookmarks in the document.

For effective mouse emulation on the keys, with MO selected and possibly locked, arrows control the pointer instead of the cursor. The space key is the left mouse button, and where applicable, space down or return is the right button. The extended space or Tab key tabs through fields in the usual way. Each arrow key causes the pointer to creep across the screen in the direction indicated. Speed is set as fast as can be controlled without overshooting. Key combinations reduce travel time by making the pointer jump if it has far to move. Command-Up or Command-Down centers the pointer vertically, and Command-Left or Command-Right centers it horizontally. A Num-(Arrow) combination produces a jump to an outer position which is always ⅙ of the screen size in from the edge. Any point can then be reached with no more than one horizontal jump, one vertical jump, and ⅙ of the screen creeping distance, which is acceptably short even at low speeds. For refinement, horizontal movements are modified to upward diagonals by the Cap shift. The Sym shift, being below the Cap shift key, modifies horizontal movements to diagonally downwards.

An improved numeric keypad takes advantage of keys optimally arranged for natural finger movements, and maintains similarity to the standard numeric keypad. As shown in FIG. 19, small characters may be added to the bottom corner of the keytops, perhaps in a distinctive color, for numerals reading left to right and bottom to top in a three-by-three array. With the primary operators in the next column to the right, these four columns are the home columns for the respective fingers, and zero is assigned to the home key (184R) for the right thumb, providing a more natural hand position than a standard keypad. The decimal point is assigned to the home row key in the inner column for the index finger, close to home for efficient operation. Mathematical operators and the decimal point are on the corresponding Symbols keys and need no additional labeling. Thus learning and labeling are minimized for a right-hand keypad.

The Delete combination “Command-Space” is appropriate as “Command-Zero” for “Clear” when using the keypad; or the Command key alone can be assigned this function. When Enter is a separate function from Equals, it falls on the Space Down (Return) key. A similar keypad can be provided on the keys arranged for the left hand. In that case the keys used, but not necessarily the functions assigned to the keys, would be a mirror image of the right-hand array.

Thus with the cursor control keys conveniently located for index finger operation, improved shifts, and logical organization, the keyboard provides the capacity and flexibility for all the editing, navigating, command, control and keypad functions to be fully integrated. Redundant subsets of keys can be eliminated, and the alphanumeric section becomes the entire keyboard. The mouse is effectively emulated, and a keyboard on the knee becomes a fully self-contained work station.

On the keytops, labelling styles classify functions. A capital letter on the upper portion of a character key represents both the Cap shift set and the default set. This holds good for the punctuation marks, since they are the same in both modes. The lower character shows the symbol selected by the Sym shift. The “above and below” locations of the characters on the keytops correspond to the locations of the shift keys that select them. The numeric labels may apply to all three character keys in a column, so the columns are labeled instead of the individual keys.

Invisible characters, normally perceived only as cursor movement, are represented by filled triangles pointing the direction of movement produced. Thus the space keys in row A are each marked with a black triangle pointing right, and space down (return) has one pointing down. Since Tab is an extended space it has two triangles pointing right. Cursor keys also produce cursor movement, but they do not type any character at all. Consistent with their “empty” movements, their triangles are empty or hollow.

Shift key labels share a common lettering style and a three-letter abbreviation of the group they select, Cap, Sym, Num. Selection of Command mode is indicated by a ship's wheel emblem. Application Override and Manual Override share a distinctive style for their two-letter initials.

The arrangement of symbols on the keys must take account of typing convenience, logic, symmetry, commands, numeric keypad compatibility, memory aids, expectations and associations. That shown in FIG. 19 is the best compromise between these contradictory considerations. With four punctuation marks duplicated in each set of letters, the thirty-character set increases the total symbol capacity to thirty-four. Assuming that binary code availability is a limiting factor; that the underline character code is re-assigned as Enter to the Command key; and that the redundant double quote is replaced by a middle dot; then three keys are not used in Sym shift mode. Row B has mathematical symbols and these three unused keys, including a symmetrical pair for possible future use. If retained, the double quote symbol belongs on the only double letter, W, and the underLine character on the L key. The home row has mostly punctuation and commercial symbols, and includes middle dot and apostrophe on the index fingers for countries using those decimal-point conventions instead of the period or comma. If no code is available for the middle dot, the character defaults to another period. The top row D has levels of parentheses in symmetrical pairs for left and right hands.

### INDUSTRIAL APPLICABILITY

The capability for exploitation in all keyboard applications is clear, and by making it possible to bring a simpler computer interface to the public, the inventive series extends the computer market to users who were previously excluded. Methods of use are similar to, and easier than, existing methods. Existing methods of keyboard manufacture are adequate for this invention, and will present no difficulty to a person skilled in the art.

I claim:

1. A family or series of related keyboards comprising at least three differing keyboards, each having at least an alphanumeric section containing a plurality of keys, said alphanumeric sections having characteristics in common so as to have at least consecutive compatibility, said compatibility being structural, or operational, or both.

2. The family or series of claim 1 wherein at least one member is a standardized keyboard generally conforming to ISO/IEC 9995, and at least one member is a keyboard that may, does, or is intended to become a new standard.

3. The family or series of claim 1 having a common key arrangement for at least some of said keys in said alphanumeric section in each member keyboard.

4. The family or series of claim 3 wherein said common key arrangement is an arrangement having a certain measure of horizontal offset between keys in adjacent rows for a group of at least four keys in at least three successive rows, said certain measure being equal to one half of the horizontal center spacing of a pair of said four keys in one of said three successive rows.

5. A member keyboard of the family or series of claim 4.

6. A multi-mode, electronic keyboard suitable for two-handed typing and having an alphanumeric section, said alphanumeric section having a plurality of character keys, and having at least one shift key, and having alternative option means for allowing two or more alternative modes of physically performing the same keyboard operation, said alternative modes being associated with different motor skills producing an identical output from said alphanumeric section.

7. The keyboard of claim 6, said means being redundancy means for redundant methods of operation including a first method in which certain characters are typed on their own keys, and a second method in which said certain characters are typed by shift-selecting them on other keys.

8. The keyboard of claim 6, said means being redundancy means for redundant methods of operation including a first method in which a particular key is operated by an index finger, and a second method in which said particular key is operated by a thumb.

9. The keyboard of claim 6, said means being redundancy means for redundant methods of operation including a first method in which at least one particular shift character is selected and typed using one digit on each hand, and a second method in which said particular shift character is selected and typed using two digits on one hand.

10. The keyboard of claim 6, said means being reversing means for using alternative configurations of columns of keys selected by reversing all or part of said keyboard.

11. The keyboard of claim 6, said means being key arrangement means for using alternative configurations of columns of keys selected on fixed keys.

12. A electronic keyboard conforming to Parts I and II of ISO/IEC 9995, and having an alphanumeric section with a plurality of keys arranged in rows and columns, and having at least a left hand group of five of said columns and a right hand group of five of said columns, characterized in that said left hand group and said right hand group are laterally symmetrical to one another.

13. The keyboard of claim 12, further characterized in that within said alphanumeric section all other finger keys provided for the left hand are in columns immediately adjacent to said left hand group, and all other finger keys provided for the right hand are in columns immediately adjacent to said right hand group.

14. The keyboard of claim 12 having a home row, and further characterized in that with respect to said home row all of the columns in said left hand group and said right hand group are not perpendicular to said home row but lean towards the opposite group.

15. The keyboard of claim 14 further characterized in that, within said left hand group and within said right hand group, adjacent columns are more widely spaced at the top than at the bottom.

16. An electronic keyboard having a plurality of keys arranged in rows and columns, and having cursor arrows arranged in a symmetrical cross on three of said rows within an alphanumeric section, characterized in that a left arrow key is immediately adjacent to a right arrow key.

17. The keyboard of claim 16 wherein said symmetrical cross determines the approximate angle of those of said columns that are immediately adjacent to said symmetrical cross and which may be assigned to the index fingers of an operator.

18. The keyboard of claim 16 wherein a home row has fourteen keys, a row immediately below said home row has fifteen keys, a row immediately above said home row has fifteen keys, and a row second above said home row has fourteen keys.

19. An electronic keyboard, with an alphanumeric section having a plurality of keys arranged in rows and columns, and having a home row, and having graphic characters, invisible characters, and at least one shift function assigned to at least some of said keys, and having a home group of five columns of finger keys for each hand, characterized in that all graphic characters within said alphanumeric section are assigned to keys within said home groups.

20. The keyboard of claim 19, further characterized in that all graphic character keys are within one key of said home row.

21. The keyboard of claim 19, also having a thumb home position for each thumb, and further characterized in that all of said shift functions and invisible characters are within one key of one of said home groups, or within one key of one of said thumb home positions.

22. The keyboard of claim 19, having a graphic character capacity of at least 90 characters.

23. An electronic keyboard having a plurality of character keys and at least two shift keys, characterized by having at least one of said shift keys located for convenient operation by an index finger.

24. The keyboard of claim 23 further characterized by having at least one of said shift keys located for convenient operation by a thumb.

25. The keyboard of claim 24 further characterized by having at least one of said shift keys arranged for convenient operation by either a thumb or an index finger, according to user preference.

26. An electronic keyboard for two-handed operation, having an alphanumeric section with a plurality of character keys and at least two shift keys, characterized by having at least one shift key for each hand arranged to facilitate one-handed shift-character operations.

27. The keyboard of claim 26 further characterized by having three shift keys for each hand arranged to facilitate one-handed shift-character operations.

28. The keyboard of claim 27 further characterized by having said three shift keys for each hand arranged for convenient operation by either a thumb or an index finger.

29. An electronic keyboard, with at least one shift key having the combined functions of a shift key and a shift-lock key, said functions being differentiated electronically in response to distinctive key operating procedures.

30. The keyboard of claim 29 wherein said operating procedures generally rely on a similar procedure in full measure and in half measure to respectively lock and release the shift, for example, double-clicking to engage an electronic lock, and a single touch to release said electronic lock.

31. An electronic keyboard with an alphanumeric section having keys arranged in rows including at least a home row, a row above said home row, and a row below said home row, with letters assigned to at least some of said keys, and having at least two shift functions, wherein one of said shift functions selects numeral characters on said home row.

32. The keyboard of claim 31 wherein the horizontal key center-spacing in individual rows is arranged as if all rows are of the same length, and as if said home row has fourteen keys, as if said row above has thirteen keys, and as if said row below has fifteen keys, irrespective of the actual number of keys in each row.

33. The keyboard of claim 31 further characterized by having three independent shift functions, and four groups of characters predominantly relating to the following natural character classifications: small letters; capital letters; numerals; and symbols.

34. The keyboard of claim 33 further characterized in that each shift group has a capacity of thirty characters.

35. A computer keyboard suitable for two-handed typing and general-purpose applications, with an alphanumeric section having:
a plurality of keys arranged in less than six rows;
at least one shift function and a basic graphic character capacity of at least 96 characters;
space, tab, and return functions, otherwise known as invisible characters;
an enter function, alone or in combination with another function;
a command function;
left-right symmetry; and
at least one pair of shift keys located closer to the center than to the ends of said rows.

36. The keyboard of claim 35 wherein said alphanumeric section has four rows of keys.

37. The keyboard of claim 36 having keys so arranged as to permit the choice of using one hand or two for the shift-selection and typing of a character.

38. The keyboard of claim 35 having editing functions and command functions integrated into said alphanumeric section so that editing and command sections are unnecessary.

39. The keyboard of claim 38 having three separate shift functions and having four groups of characters predominantly relating to small letters, capital letters, numerals, and symbols.

40. The keyboard of claim 35 having central arrow keys arranged in a symmetrical cross on three rows of keys, with a left arrow immediately adjacent to a right arrow.

41. The keyboard of claim 40 having at least one shift key arranged for convenient operation by an index finger or a thumb according to user preference.

42. The keyboard of claim 41 wherein said alphanumeric section has four rows of keys,
has editing and command functions integrated into said alphanumeric section,
has keys so arranged as to permit the choice of using one hand or two for the shift-selection and typing of a character,
has three shift functions, and
has four natural groups of characters predominantly relating to small letters, capital letters, numerals, and symbols.

43. Any keyboard generally in accordance with the spirit and principles of this invention.
